(19) United States
(12) Patent Application Publication
(10) Pub. No.: US 2006/0093715 A1
(43) Pub. Date: May 4, 2006

(54) Thermally conductive and microwave-active food molds

(75) Inventor: Juergen Weidinger, Polling (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munchen (DE)

(21) Appl. No.: 11/263,219

(22) Filed: Oct. 31, 2005

(30) Foreign Application Priority Data
Nov. 4, 2004 (DE) 10 2004 053 309.1

(51) Int. Cl. A23G 3/02

(52) U.S. Cl. 426/512

(57) ABSTRACT

Silicone elastomers comprising fillers and additives for crosslinking and stabilization for the production of thermally conductive or microwave-active, or thermally conductive and microwave-active, molds are suitable for food molds, in particular bakery molds and baking tins.

### BACKGROUND OF THE INVENTION

1. Field of the Invention

The invention relates to the use of silicone elastomers comprising fillers and additives for crosslinking and stabilization for the production of thermally conductive or microwave-active, or thermally conductive and microwave-active, molds suitable for foods, in particular bakery molds and baking tins.

2. Background Art

Molds suitable for foods and used in the confectionery industry, patisserie industry, or food industry, for example for melting, heating, and shaping of foods, e.g. butter, ice cream, chocolate, or candy, and also bakery molds and baking tins, all of which are hereinafter termed food molds, are known and are generally composed of metal, clay, porcelain, plastics such as polycarbonate, or glass. A disadvantage of use of these baking molds is that the removal or pouring of the foods from the food-compatible mold, such as a baking mold, is difficult because the molds are rigid and immobile. In some instances, complicated baking molds have therefore been developed to provide improvement, these being openable by way of a technically complicated mechanism so that the baked products can be removed. However, the resultant solution has only restricted commercial applicability because, firstly, a technically relatively complicated mechanism is needed, and secondly there is very great restriction on possible geometries of the baking molds. European Patent 0 992 195 B1 describes the use of addition-crosslinking silicone for the production of patisserie molds, of baking tins, and of baking sheets. Advantages here in relation to the abovementioned baking molds are that the silicone is elastic and flexible and therefore that the finished baked product can easily be removed in its baked form from the baking mold. The adhesion properties of the silicone give a very low cleaning cost for the silicone baking mold, because the baked product can be removed from the mold leaving substantially no residue. Furthermore, silicone has good physical and chemical resistance with respect to oxygen, UV radiation, and ozone. Other advantages are that the silicone is inert toward foods and is regarded as physiologically non-hazardous. The same advantages also apply generally for food molds such as those for the shaping of butter, chocolate, candies, or ice cream, another useful advantage here being the low-temperature flexibility of silicone elastomers.

Disadvantages of the silicones described hitherto for this type of use are the very small thermal conductivity of the material, the average thermal conductivity being from 0.2 to 0.3 W/mK. This leads to relatively long heating and cooling times and therefore to relatively high energy cost and loss of time. The chemico-physical character of these silicones moreover makes them non-microwave-active, and they cannot therefore be heated by the simple route of microwave irradiation.

Laid-open European specification EP 1 132 000 A1 describes a food mold which employs one or more ferrite-containing silicone coatings on selected portions of the mold. The ferrite filler absorbs microwaves and provides localized heating. However, the bulk of the mold, when of silicone material, does not include any ferrite material. U.S. Pat. No. 4,496,815 describes a ferrite-containing silicone coating on a substrate, this coating in turn requiring a protective coating. Korean patent specification KR 9612735 B1 describes a ferrite-filled silicone resin. U.S. Pat. No. 4,542,271 and its equivalent DE3535257 describe the use of magnetite as microwave-active filler in a plastics matrix. Here, magnetite is embedded into a rigid composition and does not come into direct contact with foods. A feature common to all of these uses described is high cost during production of the final component.

The patent specification U.S. Pat. No. 6,555,905 B2 describes the use of silicone compositions modified to have thermal conductivity for engineering uses, such as heat dissipation from the electronic components, for example in computer chips.

Ferrite as a thermally conducting filler in silicone compositions has a number of disadvantages which make it unsuitable for use as a sole filler, either to achieve a necessary level of thermal conductivity or else to achieve reproducible capability for microwave heating. Safe contact with foods is not possible because of the varying content of contaminants and of heavy metals. Susceptibility to external effects such as oxidation, as described in U.S. Pat. No. 4,496,815, can lead to a reduction in microwave activity. Frequency bands mainly used by conventional household microwaves are substantially outside of the wavelength ranges within which ferrite can be excited. Impairment of mechanical and of other physical properties during processing of the mixture, e.g. increased tack and abrasiveness, increases the difficulty of both production and use of the finished components manufactured therefrom. No significant improvement in thermal conductivity is possible, even when using high filler levels. It was impossible to achieve any increase by a factor of more than 1.3. This increased thermal conductivity is shown in column (1) in drawing 1.

Fillers having good thermal conductivity, e.g. boron nitride or aluminum oxide, have the disadvantage that they are mostly not microwave-active and that, in untreated form, they can impair the mechanical properties of the silicones used.

It is possible to embed magnetite, ferrite, or other fillers into thermosets or into high-heat-resistance elastomers such as fluororubber (FKM, FPM) or polyfluorosilicones (FVMQ), but in the first instance there is a loss of mechanical performance and flexibility and in the latter instance there is a loss of cost-effectiveness and of suitability of the products for use with foods. Processing or incorporation is moreover generally complicated when these materials are involved. These methods are therefore primarily not worthy of consideration for the production of food molds.

### SUMMARY OF THE INVENTION

It is therefore an object of the present invention to provide silicones for the production of food molds which have the desired good properties, such as high flexibility, release action, reduced composition tack or abrasiveness, and food compatibility, and also high thermal conductivity and good microwave activity in relation to frequency bands used in commercially available equipment. These and other objects have been achieved via the use of silicones which were provided with treated or untreated, or mixtures of treated and untreated, thermally conductive or microwave-active, or thermally conductive and microwave-active, fillers.

### BRIEF DESCRIPTION OF THE DRAWINGS

FIG. 1 illustrates the thermal conductivity of several filled silicone elastomer compositions.

### DETAILED DESCRIPTION OF THE PREFERRED EMBODIMENT(S)

The present invention therefore provides the use of specifically filled silicone elastomers for the production of food molds with improved thermal conductivity or microwave activity, or both thermal conductivity and microwave activity. Use of silicone elastomers filled with these specific fillers retain, without restriction the advantages of the silicones, such as low-temperature flexibility, heat resistance, release properties, food compatibility, and easy processing, while also providing that the resulting silicone elastomers have better thermal conductivity and, respectively, can also be heated efficiently and rapidly via microwave radiation, including that from conventional household microwaves, i.e. microwaves which have not been specifically frequency-modulated.

The silicone compositions treated with thermally conductive or microwave-active, or with thermally conductive and microwave-active fillers are conventional curable silicone compositions, well known to the skilled artisan, and preferably composed of the following constituents:

(A) at least one polydiorganosiloxane having at least one unsaturated group and composed of structural units of the general formula (1)
RₐR¹_{b}SiO_{(4-a-b)/2} (1)

connected chemically to one another

or at least one polydiorganosiloxane having at least one substituted hydroxy group and composed of structural units of the general formula (1) connected chemically to one another,

where
R are identical or different optionally substituted, organic hydrocarbon radicals free from aliphatic carbon-carbon multiple bonds and having up to 18 carbon atoms,
R¹ are identical or different, and are a substituted hydroxy group or a monovalent, optionally substituted hydrocarbon radical, which may optionally be bonded to the silicon atom by way of a divalent organic group, and having from 2 to 14 carbon atoms and an aliphatic carbon-carbon multiple bond (double bond or triple bond) or having at least one substituted hydroxy group,
a is 0, 1, 2, or 3, and
b is 0, 1, or 2,

with the proviso that the sum a+b is less than or equal to 3, and that the average number of radicals R¹ present per molecule is at least 2,

(B) a suitable crosslinking system, selected from the group consisting of condensation-crosslinking systems, peroxide-crosslinking systems, and addition-crosslinking systems, and

(C) from 1 to 300 parts by weight, based on (A), of at least one treated or untreated microwave-active or thermally conductive filler, or both.

Examples of radicals R are alkyl radicals such as the methyl, ethyl, n-propyl, isopropyl, n-butyl, isobutyl, tert-butyl, n-pentyl, isopentyl, neopentyls, tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the cyclopentyl, cyclohexyl, cycloheptyl, and methylcyclohexyl radicals; aryl radicals such as the phenyl, naphthyl, anthryl, and phenanthryl radicals, alkaryl radicals such as the o-, m-, and p-tolyl radicals, xylyl radicals, and ethylphenyl radicals; and aralkyl radicals such as the benzyl radical, and the α- and β-phenylethyl radicals.

Examples of substituted radicals R are haloalkyl radicals such as the 3,3,3-trifluoro-n-propyl radical, the 2,2,2,2′,2′,2′-hexafluoroisopropyl radical, and the heptafluoroisopropyl radical, and haloaryl radicals such as the o-, m-, and p-chlorophenyl radicals.

The radical R is preferably a monovalent, SiC-bonded, optionally substituted hydrocarbon radical free from aliphatic carbon-carbon multiple bonds and having from 1 to 18 carbon atoms, most preferably a monovalent, SiC-bonded hydrocarbon radical free from aliphatic carbon-carbon multiple bonds and having from 1 to 6 carbon atoms, in particular methyl and/or phenyl radicals.

The radical R¹ may be any desired groups available for an addition reaction (hydrosilylation) with a SiH-functional compound, a substituted hydroxy radical, or an aliphatic or aromatic side chain having substituted hydroxy radicals.

Radicals R¹ are alkenyl and alkynyl groups having from 2 to 16 carbon atoms, e.g. vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl, and styryl radicals, and substituted radicals, such as allyloxy and vinyloxy radicals, radicals particularly preferred here being vinyl, allyl, and hexenyl.

The molar mass of the constituent (A) is preferably from 10² to 10⁶ g/mol. Constituent (A) may, for example, be a relatively low-molecular-weight alkenyl-functional oligosiloxane, such as 1,2-divinyltetramethyldisiloxane, but may also be a highly polymerized polydimethylsiloxane having Si-bonded vinyl groups positioned along the chain or terminally, e.g. having a molar mass of 10⁵ g/mol. For present purposes, molar mass is the number average molecular weight determined by NMR. In a further embodiment, constituent (A) may be a higher-molecular-weight, i.e. oligomeric or polymeric, siloxane, which may be linear, cyclic, branched or even resin-like or network-like. Linear and cyclic polysiloxanes are preferably composed of units of the formula R₃SiO_{1/2}, R¹R₂SiO_{1/2}, R¹RSiO_{2/2} and R₂SiO_{2/2}, where R and R¹ are as defined above. Branched and network-like polysiloxanes additionally contain trifunctional and/or tetrafunctional units, where preference is given to those of the formulae RSiO_{3/2}, R¹SiO_{2/2} and SiO_{4/2}. It is, of course, also possible to use mixtures of different siloxanes meeting the criteria for the constituent (A).

As component (A), it is particularly preferable to use vinyl-functional or substituted-hydroxy-functional, substantially linear polydiorganosiloxanes whose viscosity measured at 25° C. is from 0.01 to 100,000 Pa·s, most preferably from 0.1 to 30,000 Pa·s.

The components (A) and (B) are commercially available products, or can be prepared by familiar chemical processes.

Component (C) may be used in any desired particle size, preferably from 0.1 to 1000 μm, most preferably from 1 to 500 μm, and in any desired particle size distribution, in proportions by weight, based on (A), of from 1 to 300 parts, preferably from 5 to 200 parts. Examples of component (C) having microwave-active properties are compounds selected from the group consisting of ferrites and magnetites. Magnetites are particularly preferred. Examples of component (C) with thermally conductive properties are components selected from the group consisting of metals and metal oxides, such as silver, aluminum oxide, metal carbides, non-metal carbides, metal nitrides, and non-metal nitrides, such as boron nitride, and any desired mixtures composed of these substances and substance classes. These thermally conductive fillers are preferably used in combination with microwave-active fillers. In the present invention, when ferrites are used, they are preferably not the sole fillers. Most preferably, the fillers do not include any ferrite or any substantial amount thereof.

In order to improve capability for incorporation by mixing and in order to improve the mechanical properties of the food mold, the inventive fillers may be treated with suitable chemicals, and this may take place in kneaders, mixers, dissolvers, or autoclaves, for example. Examples of suitable treatment agents are amines, alcohols, and silanes. Preference is given to silanes of the general composition Si[XRₙ]₄, where X is a non-metal atom selected from the group consisting of C, N, O, P, and R is any desired inorganic or organic radical. The compound is selected in such a way that the molecule is absorbed onto the surface of the microwave-active particles and with these enters into a physical bond, or into a chemical bond via cleavage of at least one radical at the Si—X or the X—R bond. The surface treatment with suitable agents on the one hand achieves better dispersion within the polymer matrix and on the other hand also permits linkage via vulcanization in any subsequent crosslinking process.

Magnetite (formally Fe₃O₄) or a mixture of magnetite with ferrite is particularly preferred as the microwave-active filler because, unlike pure ferrites, most of which require specific adjustment of the radiation frequency, it has high activity within the frequency bands emitted by conventional household microwaves. Furthermore, magnetite poses none of the activity-loss risk associated with many ferrites, which can lose activity via thermal conversion or oxidation processes, for example. Furthermore, the amount of critical contaminants, such as heavy metals, present in magnetite is naturally very small, but this is not the case for ferrites. Indeed, some grades of magnetite can even be regarded as free from heavy metals for food regulation purposes. Magnetite is moreover very easy to compound into the silicone matrix and does not alter the processability of the matrix. In contrast to this, the compositions formed by ferrite tend to be greasy, tacky, and difficult to process, requiring more compounding time and compounding energy. Another advantage provided by magnetite in household applications is an attractive appearance (similar to mica or to Teflon™), whereas ferrite is brown.

Particularly preferred thermally conductive fillers are low-abrasion, low-cost materials such as aluminum oxide. The thermally conductive fillers can therefore be present alone or as mixtures in the elastomer matrix, or in a mixture with microwave-active fillers. The microwave-active fillers may likewise be present alone or as mixtures in the elastomer matrix, or in a mixture with thermally conductive fillers.

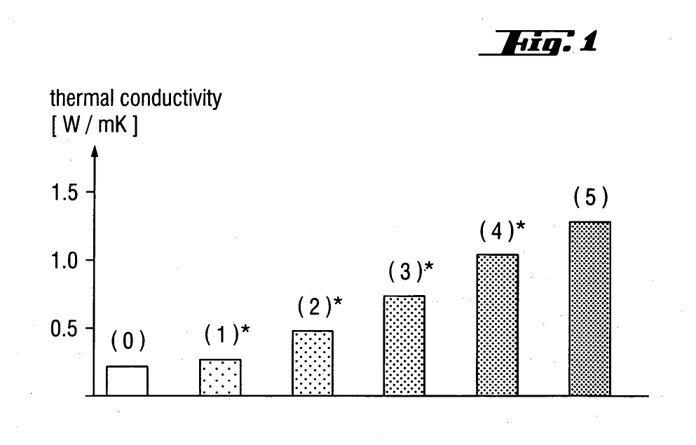

Even very small amounts of microwave-active filler are sufficient to heat the food mold, preference being given to 1 part by weight of (C) for 100 parts by weight of (A), as a function of the respective activity and dispersion level. In contrast, larger additions are needed to achieve noticeably improved thermal conductivity, i.e. more than 1 W/mK. FIG. 1 shows the thermal conductivities of primarily microwave-active silicone mixtures (1) and (2), and that of primarily thermally conductive silicone mixtures (5), and also of mixtures which comprise not only thermally conductive but also primarily microwave-active fillers (3) and (4). It is also seen from FIG. 1 that thermal conductivity can be raised by a factor of 5 and more via selection of suitable formulations.

The components (C) used are commercially available products or can be prepared by familiar chemical processes.

The inventive silicone compositions may also comprise other constituents (D) which are known to have been used for the preparation of silicone compositions. Examples of constituents (D) are fillers, such as hydrophobic and hydrophilic silicas, quartzes, and carbon blacks; inhibitors, such as alkynols, and maleic acid derivatives, stabilizers such as heat stabilizers, and color pigments.

The method of producing the food molds comprises mixing the constituents (A), (B), (C), and, if appropriate, constituents (D), and then crosslinking the material preferably at from 20 to 220° C., in particular from 20 to 190° C., in an unheated or heated casting mold, injection mold, compression mold, or transfer mold, in the form of bulk silicone or on a substrate of any desired type. The crosslinking time for the food mold depends on the geometry of the mold, on any substrate material used, and on the wall thickness of the food mold, preferably being from 10 seconds to 5 minutes.

The silicone food mold is then, if necessary, mounted or adhesive-bonded onto a substrate and, if necessary, annealed at a maximum temperature of about 200° C. for 4 hours in an oven in air.

An example of an advantage of the silicone elastomers obtained via treatment with thermally conductive or microwave-active, or thermally conductive and microwave-active, fillers is that there is no resultant restriction of previous advantages of silicone molds, e.g. free selection of the geometry of the food mold. Severe undercuts are also possible. These specifically filled compositions can, if necessary, be emulsified, suspended, dispersed, or dissolved in liquids in order, for example, to coat substrates therewith. The inventive compositions can, in particular as a function of viscosity of the constituents, and also solids content, be of low viscosity and pourable, have a pasty consistency, be pulverulent, or else be conformable, high-viscosity compositions, as is known for compositions that persons skilled in the art often refer to as single-component, room-temperature-crosslinking compositions (RTV-1), two-component, room-temperature-crosslinking compositions (RTV-2), liquid silicone rubbers (LSR), and high-temperature-crosslinking compositions (HTV). With regard to the elastomeric properties of the specifically filled silicone compositions, again the entire spectrum is encompassed, beginning with extremely soft silicone gels and passing by way of rubbery materials through highly crosslinked silicones with glassy behavior. This permits the user, by way of example, to produce any desired extrudates or moldings with microwave activity or with improved thermal conductivity, or with microwave activity and with improved thermal conductivity.

The fillers accelerate crosslinking at elevated temperatures when comparison is made with standard molds. This means faster and more efficient production. The inventive silicone compositions exhibit no significant impairment of mechanical and other physical properties when comparison is made with standard silicones, in particular when the fillers have been treated as described above. Another advantage of the specifically filled compositions is that they can be prepared in a simple process, using readily accessible starting materials, and can therefore be prepared cost-effectively. Another advantage of the compositions filled according to the invention is that, because of the increased ease of incorporation by mixing of the treated heavy fillers (C), it is possible to set the density at up to four times the initial density, this being impossible with other fillers used in the elastomer sector. This makes the food molds feel heavier and “of greater value”, i.e. perceived by the user as more stable and of greater quality.

Another advantage of the compositions filled according to the invention is that wide frequency bands can be covered via variation of the mixing ratio of two or more morphologically different microwave-active fillers. They therefore have universal use. Another advantage of the compositions filled according to the invention is that their crosslinked vulcanizates using exclusively magnetite as microwave-active filler can be used in direct contact with foods, therefore requiring no use of complicated additional coatings or substrates, such as aluminum, for avoidance of direct contact, as is the case with ferrite, for example.

Another advantage of the compositions filled according to the invention is that their crosslinked vulcanizates using exclusively or primarily magnetite as microwave-active filler do not lose microwave activity via oxidation and/or heat and/or chemicals, as is the case with ferrite alone. Another advantage of the compositions filled according to the invention is that food molds produced therefrom need less heating time or cooling time, because the thermal conductivity has been increased. This means faster and more efficient production of molded foods under milder conditions.

The molds produced from the specifically filled compositions with microwave-active fillers permit rapid heating and need no after-heating. By way of example, the baked product can remain in the mold removed from the microwave and continues to bake therein. This means a direct saving of energy. Molds produced from the inventively filled compositions give more effective caramelization of the sugars in the baked products. This makes the surface of the baked product browner and crisper when comparison is made with unfilled silicone molds. Another advantage of the compositions filled according to the invention is their rapid crosslinkability via microwave radiation when components (C) comprise an adequate amount of at least one microwave-active filler, the result being that the food molds can also be produced by means of microwave radiation.

FIG. 1 shows the thermal conductivities as a function of filler and its content. The hatching indicates the rising level of filler. Thermal conductivity is found here to be the same for compositions with treated and untreated fillers, but there is a difference in overall mechanical properties. The composition of the examples in FIG. 1 is as follows:
(0) standard silicone or parent elastomer
(1) 50 parts of ferrite for 100 parts of parent elastomer
(2) 80 parts of magnetite for 100 parts of parent elastomer
(3) 20 parts of ferrite and 40 parts of aluminum oxide for 100 parts of parent elastomer
(4) 20 parts of magnetite and 50 parts of aluminum oxide for 100 parts of parent elastomer
(5) 70 parts of aluminum oxide for 100 parts of parent elastomer

The examples identified by an asterisk (*) are microwave-active mixtures.

### EXAMPLES

Baking molds of identical geometry, content 500 ml, are produced by the processes described, one with standard silicone, and one with magnetite-filled silicone (see FIGS. 1, 2). Equal parts of an identical cake dough are charged to the molds, and the molds are placed in a standard air-circulation oven which has not been preheated. Its temperature is set to 180° C. The internal temperature of the dough and the degree of browning are then checked at regular intervals. In the improved-thermal-conductivity mold of FIG. 1, the dough reaches a thoroughly baked condition after 80% of the prescribed baking time of 30 min. The dough in the standard mold requires 30 minutes.

In a second experiment, the microwave-active baking molds are heated with an identical dough mixture in a microwave at 600 watts for 5 minutes. After this time, the dough has been thoroughly baked in the microwave-active mold. The resultant time saving is 25 minutes when comparison is made with conventional baking in standard molds, or 20 minutes when comparison is made with baking in thermally conductive form.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A food mold of a silicone elastomer composition filled with an amount of at least one filler effective to increase the thermal conductivity, microwave-absorption, or both thermal conductivity and microwave-absorption.

2. The food mold of claim 1, wherein the silicone composition comprises:
(A) at least one polydiorganosiloxane having at least one unsaturated group and composed of structural units of the general formula (1)
RₐR¹_{b}SiO_{(4-a-b)/2} (1)
connected chemically to one another, or at least one polydiorganosiloxane having at least one substituted hydroxy group and composed of structural units of the general formula (1) connected chemically to one another,
where
R are identical or different optionally substituted organic hydrocarbon radicals free from aliphatic carbon-carbon multiple bonds and having up to 18 carbon atoms,
R¹ are identical or different, and are a substituted hydroxy group or a monovalent, optionally substituted hydrocarbon radical, optionally bonded to silicon by way of a divalent organic group, and having from 2 to 14 carbon atoms and an aliphatic carbon-carbon multiple bond, or having at least one substituted hydroxy group,
a is 0, 1, 2, or 3, and
b is 0, 1, or 2,
with the proviso that the sum a+b is less than or equal to 3, and that the average number of radicals R¹ present per molecule is at least 2,
(B) a crosslinking system suitable for producing a crosslinked silicone elastomer with component A, and selected from the group consisting of condensation-crosslinking systems, peroxide-crosslinking systems, and addition-crosslinking systems, and
(C) from 1 to 300 parts by weight, based on (A), of at least one treated or untreated thermally conductive or microwave-active filler, or a mixture thereof.

3. The food mold of claim 1, wherein the average particle size of the filler (C) is from 1 to 500 μm.

4. The food mold of claim 1, wherein at least one filler (C) is selected from the group consisting of ferrites and magnetites.

5. The food mold of claim 1, wherein at least one filler (C) is selected from the group consisting of metals and metal oxides, metal carbides, non-metal carbides, metal nitrides, non-metal nitrides, and mixtures thereof.

6. The food mold of claim 5, wherein at least one filler (C) is selected from the group consisting of silver oxide, aluminum oxide, and boron nitride.

7. The food mold of claim 1, wherein at least one thermally conductive filler is used in combination with at least one microwave-active filler.

8. The food mold of claim 1, wherein at least one filler (C) has been surface-treated with amine, alcohol, or silane.

9. A crosslinkable silicone composition comprising:
(A) at least one polydiorganosiloxane having at least one unsaturated group and composed of structural units of the general formula (1)
RₐR¹_{b}SiO_{(4-a-b)/2} (1)
connected chmically to one another
or at least one polydiorganosiloxane having at least one substituted hydroxy group and composed of structural units of the general formula (1) connected chemically to one another,
where
R are identical or different and are optionally substituted, organic hydrocarbon radicals free from aliphatic carbon-carbon multiple bonds and having up to 18 carbon atoms,
R¹ are identical or different, and are a substituted hydroxy group, or a monovalent, optionally substituted hydrocarbon radical, optionally bonded to silicon by way of a divalent organic group, and having from 2 to 14 carbon atoms and an aliphatic carbon-carbon multiple bond or having at least one substituted hydroxy group,
a is 0, 1, 2, or 3, and
b is 0, 1, or 2,
with the proviso that the sum a+b is smaller than or equal to 3, and that the average number of radicals R¹ present per molecule is at least 2,
(B) a crosslinking system suitable for producing a cured silicone from component A, and selected from the group consisting of condensation-crosslinking systems, peroxide-crosslinking systems, and addition-crosslinking systems, and
(C) from 1 to 300 parts by weight, based on (A), of at least one treated or untreated, thermally conductive or microwave-active fillers, or mixtures thereof.

10. The silicone composition of claim 9, which comprises magnetite and aluminum oxide as fillers.

11. The silicone composition of claim 9, which comprises from 5 to 200 parts of fillers of magnetite and aluminum oxide, based on 100 parts of component (A).

12. The silicone composition of claim 11, which contains 1 part magnetite per 100 parts of component (A).

13. The silicone composition of claim 10, which when cured has increased microwave energy absorption as compared to an otherwise similar composition containing no magnetite.

14. In a process for heating a food product in a food mold, the improvement comprising selecting as said food mold, a food mold of claim 1.

15. In a process for heating a food product in a food mold, the improvement comprising selecting as said food mold, a food mold of claim 2.

16. In a process for heating a food product in a food mold, the improvement comprising selecting as said food mold, a food mold of claim 1, which contains magnetite, said process comprising heating by means of microwave energy.
